(19) United States
(12) Patent Application Publication
(10) Pub. No.: US 2025/0284483 A1
(43) Pub. Date: Sep. 11, 2025

(54) SYSTEMS FOR UPDATING PERIPHERAL DEVICE FIRMWARE

(71) Applicant: Geotab Inc., Oakville (CA)

(72) Inventors: Bruno Simione Beltrame, Milton (CA); Stephen Michael Fox, Oakville (CA); Xiaowei Huang, Markham (CA); Cristian Florin Ivascu, Hamilton (CA); Wenyang Liu, Richmond Hill (CA); Sanjeev Manickam, Kanata (CA); Aziz Omar, Hamilton (CA); Alexander Joshua Roth, Waterloo (CA); Dharati Bhaumik Shah, Kitchener (CA); Robert Swanson, Waterloo (CA); Jason-Jon Isaac Thomas, Mississauga (CA); Nicholas Willison, Ayr (CA)

(21) Appl. No.: 19/075,100

(22) Filed: Mar. 10, 2025

Related U.S. Application Data
(60) Provisional application No. 63/563,631, filed on Mar. 11, 2024.

(51) Int. Cl. G06F 8/65; G06F 8/71

(52) U.S. Cl. CPC G06F 8/65; G06F 8/71

(57) ABSTRACT

Multiple communication modules are used in updating firmware at a peripheral device. A peripheral device firmware version is communicated to a management server via a telematics device. An access location for updated firmware is communicated from the management server to the peripheral device via the telematics device. The peripheral device accesses and downloads the updated firmware via a long-range communication module, not via the telematics device. In this way, regular, minimalistic communication is performed via the telematics device, but major data communication is performed directly by the peripheral device.

### PRIOR APPLICATION DATA

This application claims priority to U.S. Provisional Patent Application No. 63/563,631, titled “Systems, Devices, and Methods for Updating Peripheral Device Firmware”, filed on Mar. 11, 2024.

### TECHNICAL FIELD

The present disclosure generally relates to systems, devices, and methods for updating firmware data, and in particular relates to updating firmware of peripheral devices.

### BACKGROUND

Peripheral devices can employ firmware to control operation thereof. It is desirable to be able to update such firmware as needed to optimize performance of such peripheral devices. Further, it is desirable to be able to perform these updates using existing connections or communication hardware at the peripheral devices, such that a change in connection to peripheral devices does not need to be established for the purposes of updating firmware.

### SUMMARY

According a broad aspect, the present disclosure describes a system comprising: a management server having a first at least one communication module, a first at least one processor, and a first at least one non-transitory processor-readable storage medium storing first processor-executable instructions thereon; a telematics device having a second communication module, a third communication module, a second at least one processor, and a second at least one non-transitory processor-readable storage medium storing second processor-executable instructions thereon; and a peripheral device having a fourth communication module, a fifth communication module, a third at least one processor, and a third at least one non-transitory processor-readable storage medium storing third processor-executable instructions thereon, wherein: the third processor-executable instructions cause the peripheral device to: transmit, by the fourth communication module for reception at the telematics device, an indication of a first firmware version of firmware installed at the peripheral device; the second processor-executable instructions cause the telematics device to: receive, by the second communication module, the indication of the first firmware version from the peripheral device; and transmit, by the third communication module for reception at the management server, the indication of the first firmware version; the first processor-executable instructions cause the management server to: receive, by the first at least one communication module, the indication of the first firmware version from the telematics device; compare, by the first at least one processor, the first firmware version to a second firmware version set for distribution to the peripheral device; and in response to a determination that the second firmware version is different from the first firmware version, transmit, by the first at least one communication module for reception at the telematics device, an identification of an access location for firmware data corresponding to the second firmware version; the second processor-executable instructions further cause the telematics device to: receive, by the third communication module, the identification of the access location from the management server; and transmit, by the second communication module, the identification of the access location for reception at the peripheral device; and the third processor-executable instructions further cause the peripheral device to: receive, by the fourth communication module, the identification of the access location from the telematics device; retrieve, by the fifth communication module, the firmware data corresponding to the second firmware version from the access location; and update, by the third at least one processor, the firmware installed at the peripheral device based on the firmware data retrieved from the access location.

The fourth communication module and the second communication module may comprise respective wired communication modules, for wired communication between the telematics device and the peripheral device.

The fourth communication module and the second communication module may comprise respective short-range wireless communication interfaces.

The fifth communication module may comprise a first cellular modem at the peripheral device which communicates over a first cellular network. The third communication module may comprise a second cellular modem at the telematics device which communicates over the first cellular network or a second cellular network different from the first cellular network.

The first at least one communication module may comprise a network module which communicatively couples to a cloud network or the internet.

The indication of the access location may comprise a uniform resource locator (URL).

The access location may comprise the first at least one non-transitory processor-readable storage medium.

The access location may comprise a fourth at least one non-transitory processor-readable storage medium at a datastore remote from the peripheral device, the telematics device, and the management server.

The peripheral device may further comprise at least one image sensor.

The peripheral device and the telematics device may be positioned at a vehicle, and the management server and the access location may be remote from the vehicle.

The fifth communication module may normally be in an inactive mode where communication with the management server is not enabled, and the third processor-executable instructions which cause the peripheral device to retrieve the firmware data corresponding to the second firmware version may further cause the peripheral device to: operate the fifth communication module in an active mode where communication with the management server is enabled. The third processor-executable instructions may further cause the peripheral device to: after retrieving the firmware data corresponding to the second firmware version, operate the fifth communication module in the inactive mode.

The second processor-executable instructions may further cause the telematics device to: receive vehicle identification information from a vehicle to which the telematics device is connected; and transmit, by the third communication module for reception at the management server, the vehicle identification information; and the first processor-executable instructions which cause the management server to compare the first firmware version to the second firmware version set for distribution to the peripheral device may cause the first at least one processor to compare the first firmware version to the second firmware version set for distribution to the peripheral device and compatible with the vehicle identified in the vehicle identification information.

The second firmware version may be a most recent firmware version.

The third processor-executable instructions which cause the fourth communication module to transmit the indication of the first firmware version of firmware installed at the peripheral device may cause the fourth communication module to transmit the indication of the first firmware version in response to waking of the peripheral device.

The third processor-executable instructions which cause the third at least one processor to update the firmware installed at the peripheral device based on the firmware data retrieved from the access location may cause the third at least one processor to update the firmware installed at the peripheral device after deactivation of vehicle where the peripheral device is positioned.

The first processor-executable instructions may further cause the management server to: access, at a non-transitory processor-readable storage medium accessible to the management server, a stored indication of an assumed firmware version for firmware installed at the peripheral device; compare the assumed firmware version indicated in the stored indication to the second firmware version set for distribution; and in response to a determination that the second firmware version is different from the assumed firmware version indicated in the stored indication, transmit, by the first at least one communication module for reception at the telematics device, an indication for firmware action at the peripheral device; the second processor-executable instructions may further cause the telematics device to: receive, by the third communication module of the telematics device, the indication for firmware action; and in response to receiving the indication for firmware action, transmit, by the second communication module, a wake command; the third processor-executable instructions may further cause the peripheral device to: receive, by the fourth communication module, the wake command; and wake the peripheral device; and the third processor-executable instructions which cause the fourth communication module of the peripheral device to transmit the indication of the first firmware version may cause the fourth communication module to transmit the indication of the first firmware version in response to the peripheral device being woken.

The second processor-executable instructions may further cause the telematics device to store, by the second at least one non-transitory processor-readable storage medium, the indication of the first firmware version received from the peripheral device; the second processor-executable instructions may further cause the telematics device to access the indication of the first firmware version from the second at least one non-transitory processor-readable storage medium; and the second processor-executable instructions which cause the third communication module of the telematics device to transmit the indication of the first firmware version may cause the third communication module to transmit the indication of the first firmware version as accessed from the second at least one non-transitory processor-readable storage medium.

According to another broad aspect, the present disclosure describes a system comprising: a management server having a first at least one communication module, a first at least one processor, and a first at least one non-transitory processor-readable storage medium storing first processor-executable instructions thereon; and a telematics device having a second communication module, a third communication module, a second at least one processor, and a second at least one non-transitory processor-readable storage medium storing second processor-executable instructions thereon, wherein: the second processor-executable instructions cause the telematics device to: receive, by the second communication module, an indication of a first firmware version of firmware installed at a peripheral device communicatively coupled to the telematics device; and transmit, by the third communication module for reception at the management server, the indication of the first firmware version; the first processor-executable instructions cause the management server to: receive, by the first at least one communication module, the indication of the first firmware version from the telematics device; compare, by the first at least one processor, the first firmware version to a second firmware version set for distribution to the peripheral device; and in response to a determination that the second firmware version is different from the first firmware version, transmit, by the first at least one communication module for reception at the telematics device, an identification of an access location for firmware data corresponding to the second firmware version; and the second processor-executable instructions further cause the telematics device to: receive, by the third communication module, the identification of the access location from the management server; and transmit, by the second communication module, the identification of the access location for reception and subsequent retrieval of the firmware data corresponding to the second firmware version from the access location by the peripheral device.

The second communication module may comprise a wired communication module, for wired communication between the telematics device and the peripheral device.

The second communication module may comprise a short-range wireless communication module.

The third communication module may comprise a cellular modem at the telematics device which communicates over a cellular network.

The first at least one communication module may comprise a network module which communicatively couples to a cloud network or the internet.

The indication of the access location may comprise a uniform resource locator (URL).

The access location may comprise the first at least one non-transitory processor-readable storage medium.

The access location may comprise another at least one non-transitory processor-readable storage medium at a datastore remote from the peripheral device, the telematics device, and the management server.

The telematics device may be positioned at a vehicle where the peripheral device is positioned, and the management server and the access location are remote from the vehicle.

The second processor-executable instructions may further cause the telematics device to: receive vehicle identification information from a vehicle to which the telematics device is connected; and transmit, by the third communication module for reception at the management server, the vehicle identification information; and the first processor-executable instructions which cause the management server to compare the first firmware version to the second firmware version set for distribution to the peripheral device may cause the first at least one processor to compare the first firmware version to the second firmware version set for distribution to the peripheral device and compatible with the vehicle identified in the vehicle identification information.

The second firmware version may be a most recent firmware version.

The second processor-executable instructions may further cause the telematics device to store, by the second at least one non-transitory processor-readable storage medium, the indication of the first firmware version; the second processor-executable instructions may further cause the telematics device to access the indication of the first firmware version from the second at least one non-transitory processor-readable storage medium; and the second processor-executable instructions which cause the third communication module of the telematics device to transmit the indication of the first firmware version may cause the third communication module to transmit the indication of the first firmware version as accessed from the second at least one non-transitory processor-readable storage medium.

According to yet another broad aspect, the present disclosure describes a method performed between a management server having a first communication module, a telematics device having a second communication module and a third communication module, and a peripheral device have a fourth communication module and a fifth communication module, the method comprising: transmitting, by the fourth communication module of the peripheral device to the second communication module of the telematics device, an indication of a first firmware version of firmware installed at the peripheral device; transmitting, by the third communication module of the telematics device to the first communication module of the management server, the indication of the first firmware version; comparing, by a first at least one processor of the management server, the first firmware version to a second firmware version set for distribution to the peripheral device; in response to a determination that the second firmware version is different from the first firmware version, transmitting, by the first at least one communication module of the management server to the third communication module of the telematics device, an identification of an access location for firmware data corresponding to the second firmware version; transmitting, by the second communication module of the telematics device, the identification of the access location to the fourth communication module of the peripheral device;

retrieving, by the fifth communication module of the peripheral device, the firmware data corresponding to the second firmware version from the access location; and updating, by a second at least one processor at the peripheral device, the firmware installed at the peripheral device based on the firmware data retrieved from the access location.

The fifth communication module may normally be in an inactive mode where communication with the management server is not enabled, and retrieving the firmware data corresponding to the second firmware version may further comprise: operating the fifth communication module in an active mode where communication with the management server is enabled.

The third processor-executable instructions may further cause the peripheral device to: after retrieving the firmware data corresponding to the second firmware version, operating the fifth communication module in the inactive mode.

The method may further comprise: receiving, by the telematics device, vehicle identification information from a vehicle to which the telematics device is connected; and transmitting, by the third communication module for reception at the management server, the vehicle identification information, and comparing the first firmware version of the peripheral device to a second firmware version set for distribution to the peripheral device may comprise comparing the first firmware version of the peripheral device to a second firmware version set for distribution to the peripheral device and compatible with the vehicle identified in the vehicle identification information.

Transmitting, by the fourth communication module of the peripheral device to the second communication module of the telematics device, the indication of the first firmware version of firmware installed at the peripheral device may comprise transmitting the indication of the first firmware version in response to waking of the peripheral device.

Updating, by the second at least one processor, the firmware installed at the peripheral device based on the firmware data retrieved from the access location may comprise updating the firmware installed at the peripheral device after deactivation of vehicle where the peripheral device is positioned.

The method may further comprise: accessing, at a non-transitory processor-readable storage medium accessible to the management server, a stored indication of an assumed firmware version for firmware installed at the peripheral device; comparing, by the first at least one processor, the assumed firmware version indicated in the stored indication to the second firmware version set for distribution; in response to a determination that the second firmware version is different from the assumed firmware version indicated in the stored indication, transmitting, by the first at least one communication module for reception at the telematics device, an indication for firmware action at the peripheral device; receiving, by the third communication module of the telematics device, the indication for firmware action; in response to receiving the indication for firmware action, transmitting, by the second communication module, a wake command; receiving, by the fourth communication module, the wake command; and waking the peripheral device. Transmitting, by the fourth communication module of the peripheral device, the indication of the first firmware version may comprise transmitting the indication of the first firmware version in response to the peripheral device being woken.

The method may further comprise: storing, by the second at least one non-transitory processor-readable storage medium of the telematics device, the indication of the first firmware version received from the peripheral device; and accessing, by the telematics device, the indication of the first firmware version from the second at least one non-transitory processor-readable storage medium. Transmitting, by the third communication module of the telematics device, the indication of the first firmware version may comprise transmitting the indication of the first firmware version as accessed from the second at least one non-transitory processor-readable storage medium.

According to another broad aspect, the present disclosure describes a system comprising: a management server having a first at least one communication module, a first at least one processor, and a first at least one non-transitory processor-readable storage medium storing first processor-executable instructions thereon; a telematics device having a second communication module, a third communication module, a second at least one processor, and a second at least one non-transitory processor-readable storage medium storing second processor-executable instructions thereon; and a peripheral device having a fourth communication module, a fifth communication module, a third at least one processor, and a third at least one non-transitory processor-readable storage medium storing third processor-executable instructions thereon, wherein: the third processor-executable instructions cause the peripheral device to: transmit, by the fourth communication module for reception at the telematics device, an indication of a first firmware version of firmware installed at the peripheral device; the second processor-executable instructions cause the telematics device to: receive, by the second communication module, the indication of the first firmware version from the peripheral device; and transmit, by the third communication module for reception at the management server, the indication of the first firmware version; the first processor-executable instructions cause the management server to: receive, by the first at least one communication module, the indication of the first firmware version from the telematics device; compare, by the first at least one processor, the first firmware version to a second firmware version set for distribution to the peripheral device; and in response to a determination that the second firmware version is different from the first firmware version, transmit, by the first at least one communication module for reception at the telematics device, a firmware action message; the second processor-executable instructions further cause the telematics device to: receive, by the third communication module, the firmware action message from the management server; and transmit, by the second communication module, a wake command for reception at the peripheral device; and the third processor-executable instructions further cause the peripheral device to: receive, by the fourth communication module, the wake command from the telematics device; wake the peripheral device in response to the wake command; transmit, by the fourth communication module, a request for firmware data access location for reception at the telematics device; the second processor-executable instructions further cause the telematics device to: receive, by the second communication module, the request for firmware data access location; transmit, by the third communication module, the request for firmware data access location for reception at the management server; the first processor-executable instructions further cause the management server to: receive, by the first communication module, the request for firmware data access location from the telematics device; transmit, by the first communication module for reception at the telematics device in response to the request for firmware data access location, an indication of an access location for firmware data corresponding to the second firmware version; the second processor-executable instructions further cause the telematics device to: receive, by the third communication module, the indication of the access location for firmware data corresponding to the second firmware version from the management server; and transmit, by the second communication module, the indication of the access location for firmware data corresponding to the second firmware version for reception at the peripheral device; and the third processor-executable instructions further cause the peripheral device to: receive, by the fourth communication module of the peripheral device, the indication of the access location for firmware data corresponding to the second firmware version; retrieve, by the fifth communication module, the firmware data corresponding to the second firmware version from the access location; and update, by the third at least one processor, the firmware installed at the peripheral device based on the firmware data retrieved from the access location.

The fourth communication module and the second communication module may comprise respective wired communication modules, for wired communication between the telematics device and the peripheral device. The fourth communication module and the second communication module may comprise respective short-range wireless communication interfaces.

The fifth communication module may comprise a first cellular modem at the peripheral device which communicates over a first cellular network. The third communication module may comprise a second cellular modem at the telematics device which communicates over the first cellular network or a second cellular network different from the first cellular network. The first at least one communication module may comprise a network module which communicatively couples to a cloud network or the internet.

The indication of the access location may comprise a uniform resource locator (URL).

The firmware data access location may comprise the first at least one non-transitory processor-readable storage medium.

The firmware data access location may comprise a fourth at least one non-transitory processor-readable storage medium at a datastore remote from the peripheral device, the telematics device, and the management server.

The peripheral device may further comprise at least one image sensor.

The peripheral device and the telematics device may be positioned at a vehicle, and the management server and the access location may be remote from the vehicle.

The fifth communication module may normally be in an inactive mode where communication with the management server is not enabled, and the third processor-executable instructions which cause the peripheral device to retrieve the firmware data corresponding to the second firmware version may further cause the peripheral device to: operate the fifth communication module in an active mode where communication with the management server is enabled. The third processor-executable instructions may further cause the peripheral device to: after retrieving the firmware data corresponding to the second firmware version, operate the fifth communication module in the inactive mode.

The second processor-executable instructions may further cause the telematics device to: receive vehicle identification information from a vehicle to which the telematics device is connected; and transmit, by the third communication module for reception at the management server, the vehicle identification information; and the first processor-executable instructions which cause the management server to compare the first firmware version to the second firmware version set for distribution to the peripheral device may cause the first at least one processor to compare the first firmware version to the second firmware version set for distribution to the peripheral device and compatible with the vehicle identified in the vehicle identification information.

The second firmware version may be a most recent firmware version.

The first processor-executable instructions may further cause the management server to: store, at a non-transitory processor-readable storage medium accessible to the management server, an indication of the first firmware version; and access, at the non-transitory processor-readable storage medium accessible to the management server, the stored indication of the first firmware version; and the first processor-executable instructions which cause the first at least one processor to compare the first firmware version to a second firmware version set for distribution may cause the first at least one processor to compare the first firmware version indicated in the stored indication to the second firmware version set for distribution.

The second processor-executable instructions may further cause the telematics device to store, by the second at least one non-transitory processor-readable storage medium, the indication of the first firmware version received from the peripheral device; the second processor-executable instructions may further cause the telematics device to access the indication of the first firmware version from the second at least one non-transitory processor-readable storage medium; and the second processor-executable instructions which cause the third communication module of the telematics device to transmit the indication of the first firmware version may cause the third communication module to transmit the indication of the first firmware version as accessed from the second at least one non-transitory processor-readable storage medium.

According to yet another broad aspect, the present disclosure describes a method performed between a management server having a first communication module, a telematics device having a second communication module and a third communication module, and a peripheral device having a fourth communication module and a fifth communication module, the method comprising: transmitting, by the fourth communication module of the peripheral device to the second communication module of the telematics device, an indication of a first firmware version of firmware installed at the peripheral device; transmitting, by the third communication module of the telematics device to the first communication module of the management server, the indication of the first firmware version; comparing, by a first at least one processor of the management server, the first firmware version to a second firmware version set for distribution to the peripheral device; in response to a determination that the second firmware version is different from the first firmware version, transmitting, by the first at least one communication module of the management server to the third communication module of the telematics device, a firmware action message; transmitting, by the second communication module of the telematics device, a wake command to the fourth communication module of the peripheral device; waking the peripheral device in response to the wake command; transmitting, by the fourth communication module of the peripheral device, a request for firmware data access location to the second communication module of the telematics device; transmitting, by the third communication module of the telematics device, the request for firmware data access location to the first communication module of the management server; transmitting, by the first communication module of the management server in response to the request for firmware data access location to the third communication module of the telematics device, an indication of an access location for firmware data corresponding to the second firmware version; transmitting, by the second communication module of the telematics device to the fourth communication module of the peripheral device, the indication of the access location for firmware data corresponding to the second firmware version; retrieving, by the fifth communication module of the peripheral device, the firmware data corresponding to the second firmware version from the access location; and updating, by a second at least one processor at the peripheral device, the firmware installed at the peripheral device based on the firmware data retrieved from the access location.

The fifth communication module may normally be in an inactive mode where communication with the management server is not enabled, and retrieving the firmware data corresponding to the second firmware version may further comprise: operating the fifth communication module in an active mode where communication with the management server is enabled. The method may further comprise: after retrieving the firmware data corresponding to the second firmware version, operating the fifth communication module in the inactive mode.

The method may further comprise: receiving, by the telematics device, vehicle identification information from a vehicle to which the telematics device is connected; and transmitting, by the third communication module for reception at the management server, the vehicle identification information. Comparing the first firmware version of the peripheral device to a second firmware version set for distribution to the peripheral device may comprise comparing the first firmware version of the peripheral device to a second firmware version set for distribution to the peripheral device and compatible with the vehicle identified in the vehicle identification information.

The second firmware version may be a most recent firmware version.

The method may further comprise: storing, at a non-transitory processor-readable storage medium accessible to the management server, an indication of the first firmware version; and accessing, at the non-transitory processor-readable storage medium accessible to the management server, the stored indication of the first firmware version. Comparing, by the first at least one processor, the first firmware version to the second firmware version set for distribution may cause the first at least one processor to compare the first firmware version indicated in the stored indication to the second firmware version set for distribution.

The method may further comprise: storing, by the second at least one non-transitory processor-readable storage medium of the telematics device, the indication of the first firmware version received from the peripheral device; and accessing, by the telematics device, the indication of the first firmware version from the second at least one non-transitory processor-readable storage medium. Transmitting, by the third communication module of the telematics device, the indication of the first firmware version may comprise transmitting the indication of the first firmware version as accessed from the second at least one non-transitory processor-readable storage medium.

### BRIEF DESCRIPTION OF THE DRAWINGS

Exemplary non-limiting embodiments are described with reference to the accompanying drawings in which:

FIG. 1 is a schematic view of a telematics system.

FIG. 2 is a schematic view of a system of devices which are pertinent to a vehicle, in accordance with at least one illustrated example.

FIG. 3 is a schematic view of a system of devices which communicate with each other, in accordance with at least one illustrated example.

FIG. 4 is a flowchart diagram of a method for updating firmware at a peripheral device.

FIG. 5 is a flowchart diagram of a method for sending a wake command to a peripheral device.

FIG. 6 is a flowchart diagram of a method for requesting an access location for and obtaining firmware data.

### DETAILED DESCRIPTION

The present disclosure details systems, methods, and devices for updating firmware at peripheral devices. The present disclosure sees particular value in vehicle data collection systems, where telematics devices and coupled peripheral devices are positioned at vehicles.

Telematics systems have been employed by fleet owners to monitor use and performance of vehicles in the fleet. A telematics system monitors a vehicle using an onboard telematics device for gathering and transmitting vehicle operation information. For instance, fleet managers can employ telematics to have remote access to real time operation information of each vehicle in a fleet. A vehicle may include a car, truck, recreational vehicle, heavy equipment, tractor, snowmobile or other transportation asset. A telematics device may detect environmental operating conditions associated with a vehicle, for example, outside temperature, attachment status of an attached trailer, and temperature inside an attached refrigeration trailer. A telematics device may also detect operating conditions of an associated vehicle, such as position, (e.g., geographic coordinates), speed, and acceleration, time of day of operation, distance traveled, stop duration, customer location, idling duration, driving duration, among others. Hence, the telematics device collects and transmits data to the telematics system that is representative of the vehicle operation and usage execution. This data may be collected over a time period of sufficient duration to allow for pattern recognition of the vehicle's operation. In an example the duration may be determined to be a number of days between 30 days and 90 days, though in practice any appropriate number of days could be implemented as the duration.

In an exemplary telematics system, raw vehicle data, including vehicle operation information indicative of a vehicle's operating conditions, is transmitted from an onboard telematics device to a remote subsystem, (e.g., data management system which may comprise a cloud system or a management system). Raw vehicle data may include information indicating the identity of the onboard telematics device (e.g., device identifier, device ID) and/or the identity of the associated vehicle the onboard telematics device is aboard. Specific and non-limiting examples of raw vehicle data includes device ID data, position data, speed data, ignition state data, (e.g. indicates whether vehicle ignition is ON or OFF), and datetime data indicative of a date and time vehicle operating conditions were logged by the telematics device. Raw vehicle data transmitted and collected over a period of time forms historical vehicle data which may be stored by the remote subsystem for future analysis of a single vehicle or fleet performance. In practice, a single fleet may comprise many vehicles, and thus large volumes of raw vehicle data (e.g., terabytes, petabytes, exabytes . . . ) may be transmitted to, and stored by, a remote subsystem. Throughout this application, vehicle data collected, processed, and/or transmitted by a telematics monitoring device can be broadly included in “telematic data”, among other types of data such as location data discussed later.

In other exemplary telematics systems, a telematics device can have at least one processing unit thereon which processes or filters raw vehicle data, and transmits processed or filtered data. Such systems can reduce the bandwidth required for transmission and required storage capacity for transmitted data.

The use of telematics systems has resulted in improved performance and maintenance of vehicles in the fleet. Additionally, data from telematics systems can also be useful to analyze traffic, to provide information for infrastructure design, planning, and implementation.

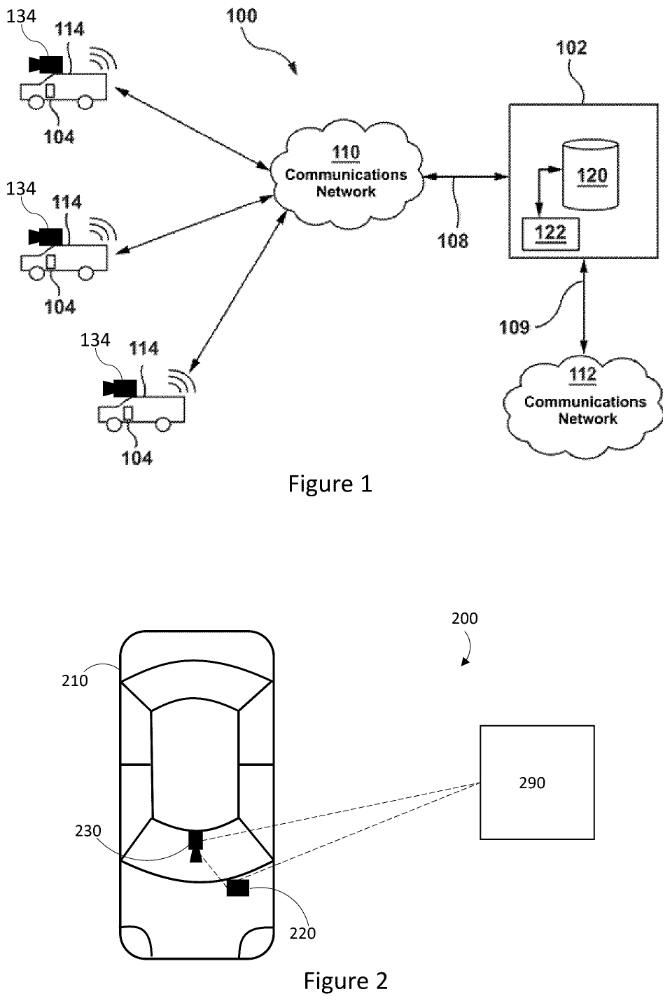

Illustrated in FIG. 1 is a simplified block diagram of an exemplary telematics system for gathering and storing vehicle operation information. Telematics system 100 comprises telematics subsystem 102 having a first network interface 108 and onboard telematics devices 104 of vehicles 114 communicatively coupled therewith via communication network 110.

The telematics subsystem 102 in an implementation comprises a management system which is a managed cloud data warehouse for performing analytics on data stored therein. In another implementation, the management system may comprise a plurality of management systems, datastores, and other devices, configured in a centralized, distributed or other arrangement. In some implementations, one or more different management systems may be employed and configured separately or in a centralized, distributed or other arrangement. In the illustrated example, telematics subsystems 102 includes at least one non-transitory processor-readable storage medium 120 and at least one processor 122. The at least one non-transitory processor-readable storage medium 120 can store data on which analytics is performed, and/or can store instructions thereon. Said instructions, when executed by the at least one processor 122, cause the telematics subsystem to perform the desired operations, analysis, or data collection/aggregation. The telematics subsystem 102 can also be referred to as a management server. Such a management server can be a single device, or can be a distributed arrangement as discussed above.

Communication network 110 may include one or more computing systems and may be any suitable combination of networks or portions thereof to facilitate communication between network components. Some examples of networks include, Wide Area Networks (WANs), Local Area Networks (LANs), Wireless Wide Area Networks (WWANs), data networks, cellular networks, voice networks, among other networks, which may be wired and/or wireless. Communication network 110 may operate according to one or more communication protocols, such as, General Packet Radio Service (GPRS), Universal Mobile Telecommunications Service (UMTS), GSM, Enhanced Data Rates for GSM Evolution (EDGE), LTE, CDMA, LPWAN, Wi-Fi™, Bluetooth™, Ethernet, HTTP/S, TCP, and CoAP/DTLS, or other suitable protocol. Communication network 110 may take other forms as well.

Telematics system 100 may comprise another network interface 109 for communicatively coupling to another communication network 112. In an implementation, communication network 112 may comprise a communication gateway between the fleet owners and the telematics system 100.

Also shown in FIG. 1 are vehicles 114, each thereof having aboard the onboard telematics devices 104. A vehicle may include a car, truck, recreational vehicle, heavy equipment, tractor, snowmobile, or other transportation asset. Onboard telematics devices 104 may transmit raw vehicle data associated with vehicles 114 through the communication network 110 to the telematics subsystem 102.

Three telematics devices 104 are described in this example for explanation purposes only and embodiments are not intended to be limited to the examples described herein. In practice, a telematics system may comprise many vehicles 114, such as hundreds, thousands and tens of thousands or more. Thus, huge volumes of raw vehicle data may be received and stored by remote telematics subsystem 102.

In general, telematics devices 104 comprise sensing modules configured for sensing and/or measuring a physical property that may indicate an operating condition of a vehicle. For example, sensing modules may sense and/or measure a vehicle's position, (e.g., GPS coordinates), speed, direction, rates of acceleration or deceleration, for instance, along the x-axis, y-axis, and/or z-axis, altitude, orientation, movement in the x, y, and/or z direction, ignition state, transmission and engine performance, and times of operation among others. One of ordinary skill in the art will appreciate that these are but a few types of vehicle operating conditions that may be detected.

Telematics device 104 may comprise a sensing module for determining vehicle position. For instance, the sensing module may utilize Global Positioning System (GPS) technology (e.g., GPS receiver) for determining the geographic position (Lat/Long coordinates) of vehicle 114. Alternatively, the sensing module utilizes another a global navigation satellite system (GNSS) technology, such as, GLONASS or BeiDou. Alternatively, the sensing module may further utilize another kind of technology for determining geographic position. In addition, the sensing module may provide other vehicle operating information, such as speed. Alternatively, the telematics device 104 may communicate with a plurality of sensing modules for a vehicle.

Alternatively, vehicle position information may be provided according to another geographic coordinate system, such as, Universal Transverse Mercator, Military Grid Reference System, or United States National Grid.

In general, a vehicle 114 may include various control, monitoring and/or sensor modules for detecting vehicle operating conditions. Some specific and non-limiting examples include, an engine control unit (ECU), a suspension and stability control module, a headlamp control module, a windscreen wiper control module, an anti-lock braking system module, a transmission control module, and a braking module. A vehicle may have any combination of control, monitoring and/or sensor modules. A vehicle may include a data/communication bus accessible for monitoring vehicle operating information, provided by one or more vehicle control, monitoring and/or sensor modules. A vehicle data/communication bus may operate according to an established data bus protocol, such as the Controller Area Network bus (CAN-bus) protocol that is widely used in the automotive industry for implementing a distributed communications network. Specific and non-limiting examples of vehicle operation information provided by vehicle monitoring and/or sensor modules include, ignition state, fuel tank level, intake air temp, and engine RPM among others.

Telematics device 104 may comprise a monitoring module operable to communicate with a data/communication bus of vehicle 114. The monitoring module may communicate via a direct connection, such as, electrically coupling, with a data/communication bus of vehicle 114 via a vehicle communication port, (e.g., diagnostic port/communication bus, OBDII port). Alternatively, the monitoring module may comprise a wireless communication interface for communicating with a wireless interface of the data/communication bus of vehicle 114. Optionally, a monitoring module may communicate with other external devices/systems that detect operating conditions of the vehicle.

Telematics device 104 may be configured to wirelessly communicate with telematics subsystem 102 via a wireless communication module. In some embodiments, telematics device 104 may directly communicate with one or more networks outside vehicle 114 to transmit data (such as telematic data) to telematics subsystem 102. A person of ordinary skill will recognize that functionality of some modules may be implemented in one or more devices and/or that functionality of some modules may be integrated into the same device.

Telematics devices 104 may transmit raw vehicle data (or telematic data), indicative of vehicle operation information collected thereby, to telematics subsystem 102. The raw vehicle data may be transmitted at predetermined time intervals, (e.g. heartbeat), intermittently, and/or according to other predefined conditions. Raw vehicle data (or telematic data) transmitted from telematics devices 104 may include information indicative of device ID, position, speed, ignition state, and date and time operating conditions are logged, for instance, in an onboard datastore. One of ordinary skill in the art will appreciate that raw vehicle data may comprise data indicative of numerous other vehicle operating conditions. Raw vehicle data may be transmitted from a monitoring device when a vehicle is moving, stationary, and during both ON and OFF ignition states.

Also shown in FIG. 1 are image sensors 134, each aboard a respective vehicle 104. Each of image sensors 134 could for example be a camera, such as a video camera. Such image sensors capture image data (or video data, as a sequence of images) in a field of view of the respective image sensor. In some cases, an image sensor is positioned and oriented to capture image data representing a field of view outside the vehicle (e.g. a dash cam, rear view cam, or other camera pointed externally to the vehicle). In some cases, an image sensor is positioned and oriented to capture image data representing a field of view inside the vehicle (e.g. a driver-facing camera, a camera aimed at an instrument panel, or other camera pointed internally in the vehicle).

Similar to telematic data, image data captured by image sensors 134 can be transmitted to telematics subsystem 102 by communications network 110. In some implementations, communication hardware of telematics devices can have limited bandwidth capabilities. For example, transmission speed or quantity from a telematics device 104 can be throttled to reduce power consumption. As another example, a telematics device 104 may be old, such that the communication hardware thereon is inherently limited in capabilities. In such cases, communication hardware of the telematics device 104 may be inadequate or inappropriate for transmitting image data from an image sensor 134 over communications network 110. To address this, image sensors 134 may include dedicated communication hardware for communicating over communications network 110. This is described in detail with reference to FIG. 2 below.

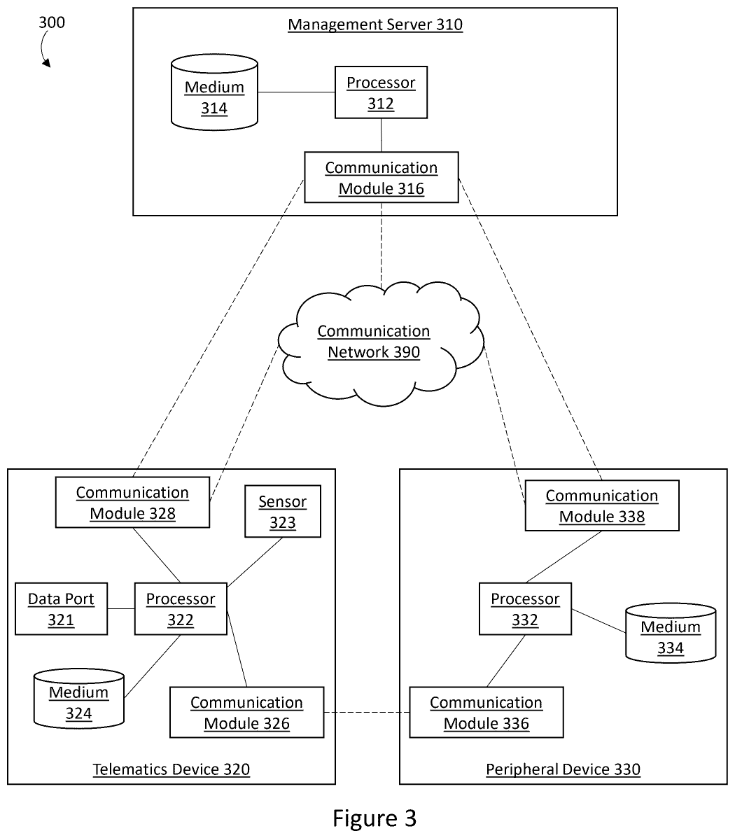

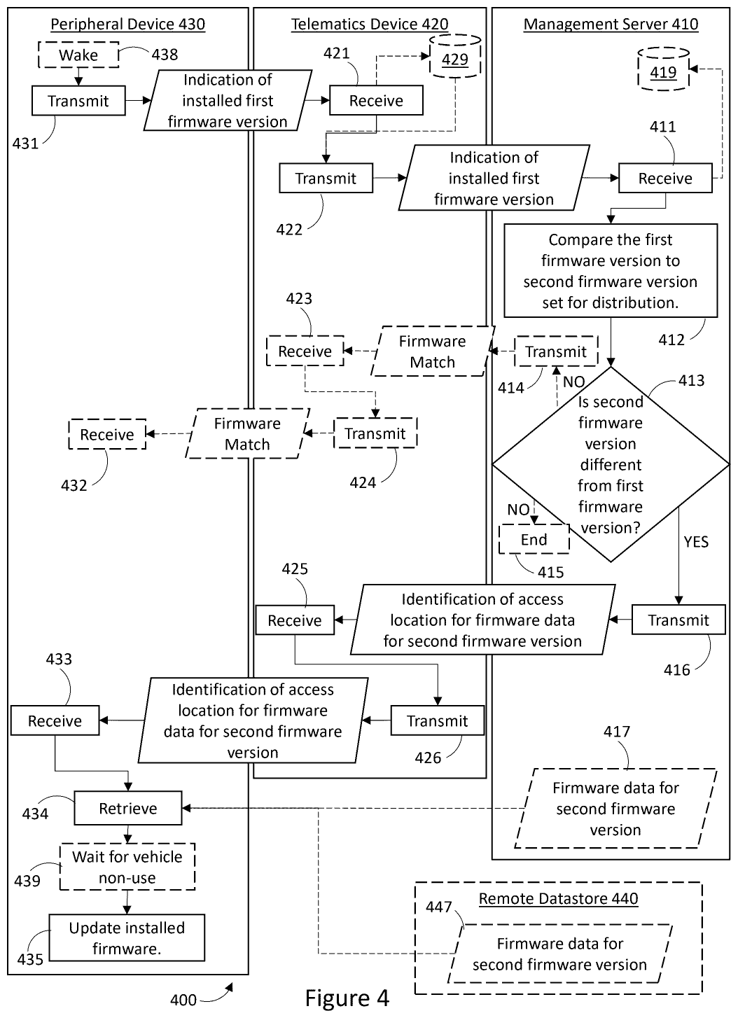

FIG. 2 is a schematic diagram which illustrates an exemplary system 200, where a peripheral device and telematics device are positioned at a vehicle and able to communicate with a management server remote from the vehicle. In particular, FIG. 2 shows a vehicle 210. In the illustrated example, vehicle 210 is a sedan-type car, but this discussion applies to any appropriate type of vehicle, such as those discussed earlier. A telematics device 220 is positioned at vehicle 210. The telematics device 220 could be installed (permanently or removably) to the vehicle 210. For example, the telematics device may comprise a monolithic device which plugs into a data port of vehicle 210 (such as the OBDII port) to receive power and data from the vehicle. As another example, the telematics device may comprise multiple components positioned in different locations of the vehicle which communicate with each other. A peripheral device 230 is also positioned at vehicle 210. In the illustrated example, the peripheral device 230 is an image capture device installed to vehicle 210 so as to look out the front windshield of vehicle 210. In alternative implementations, more than one image capture device can be positioned at the vehicle, pointed in any appropriate direction (e.g. a rear-facing camera, in-cab facing camera, side facing cameras, etc.) A plurality of image capture devices can be implemented collectively as a peripheral device (e.g. the image capture devices are controlled commonly), or as a plurality of respective peripheral devices. In alternative implementations, the peripheral device could comprise at least one device which is not an image capture device, such as peripheral sensors, a peripheral battery device, a key activation or storage device, or any other appropriate device. Telematic device 220 and peripheral device 230 are communicatively coupled with each other; detailed implementations are discussed later with reference to FIG. 3.

FIG. 2 also shows a management server 290. As discussed earlier with reference to telematics subsystem 102, management server 290 can comprise one device, or can comprise a plurality of devices or distributed computing resources (e.g. over a cloud or server warehouse). Telematic device 220 and peripheral device 230 are each communicatively coupled to management server 290. While FIG. 2 illustrates this communicative coupling in a direct manner, the communicative coupling can be indirect (e.g. over a communication network such as a cellular or internet network.

FIG. 3 is a schematic diagram showing a system 300 including exemplary hardware for the management servers, telematics devices, and peripheral devices discussed herein. The hardware shown in FIG. 3 is not exhaustive, and any appropriate additional hardware can be included in each of the devices.

FIG. 3 shows a management server 310, which includes a first at least one processor 312, a first at least one non-transitory processor-readable storage medium 314, and a first communication module 316. The first at least one non-transitory processor-readable storage medium 314 can store (among other data) processor-executable instructions which, when executed by the first at least one processor 312, control operation of the management server 310 (e.g. cause the management server 310 to perform any appropriate actions, such as actions in methods 400, 500, and/or 600 discussed later with reference to FIGS. 4, 5, and 6).

FIG. 3 also shows a telematics device 320, which includes a second at least one processor 322, a second at least one non-transitory processor-readable storage medium 324, a second communication module 326, and a third communication module 328. Telematics device 320 also includes means for receiving, collecting, or capturing telematics data as described earlier. In the illustrated example in FIG. 3, telematics device 320 includes a data port 321, which connects to a corresponding port of a vehicle (e.g. a diagnostics port such as an OBDII port), in order to receive vehicle-related data from the vehicle. Also in the illustrated example, telematics device 320 includes at least one sensor 323, which captures sensor data related to the vehicle (such as location data, inertial data, or any other appropriate type of sensor data as discussed earlier). The second at least one non-transitory processor-readable storage medium 324 can store (among other data) processor-executable instructions which, when executed by the second at least one processor 322, control operation of the telematics device 320 (e.g. cause the telematics device 320 to perform any appropriate actions, such as actions in methods 400, 500, and/or 600 discussed later with reference to FIGS. 4, 5, and 6).

FIG. 3 also shows a peripheral device 330 which includes at least one third processor 332, at least one third non-transitory processor-readable storage medium 334, a fourth communication module 336, and a fifth communication module 338. Peripheral device 330 can be any appropriate type of peripheral device (e.g. image capture device, battery device, processing device, key-storage device, as non-limiting examples). To this end, peripheral device 330 can also include any hardware appropriate to enable peripheral device 330 to serve its intended purpose. The third at least one non-transitory processor-readable storage medium 334 can store (among other data) processor-executable instructions which, when executed by the third at least one processor 332, control operation of the peripheral device 330 (e.g. cause the peripheral device 330 to perform any appropriate actions, such as actions in methods 400, 500, and/or 600 discussed later with reference to FIGS. 4, 5, and 6).

The labels “first”, “second”, “third”, “fourth”, and “fifth” are merely to label different components, and do not indicate or imply any specific sequence or ordinance of components.

The first communication module 316, third communication module 328, and fifth communication module 338 are long-range communication modules, for communication between management server 310 and telematics device 320 and/or peripheral device 330. For example, communication modules 316, 328, and 338 can be cellular modems, which enable communication of management server 310, telematics device 320, and peripheral device 330 over at least one cellular network. Such a cellular network is one example of communication network 390 shown in FIG. 3, via which management server 310 communicates with telematics device 320 and peripheral device 330. Communication network 390 is optional, and in some implementations management server 310 could communicate directly with telematics device 320 and peripheral device 330, as also shown in FIG. 3 by dashed lines. The first communication module 316, third communication module 328, and fifth communication module 338 do not all have to be the same type of modules, nor is communication network 390 limited to a single communication network. For example, communication module 316 can be an internet capable module (e.g. an ethernet port, a wireless network module such as a WiFi™ module, or any other appropriate module) which connects to the internet; communication module 328 can be a cellular module which connects to a cellular network of a first cellular provider; and communication module 338 can be a cellular module which connects to a cellular network of a second cellular provider. In such an implementation, each of the first communication module 316, third communication module 328, and fifth communication module 338 connect to the internet and communicate over the internet, but via different mechanisms.

Second communication module 326 and fourth communication module 336 are generally short-range communication modules. In some implementations, second communication module 326 and fourth communication module 336 can be wired communication modules (such as USB ports), such that telematics device 320 and peripheral device 330 communicate with each other over a wired connection. In other implementations, second communication module 326 and fourth communication module 336 are wireless communication modules, such as Bluetooth™, Zigbee™, WiFi™, or any other appropriate type of short-range wireless connection.

FIG. 4 is a flowchart diagram which illustrates an exemplary method 400 for updating firmware at a peripheral device. Method 400 as illustrated includes acts performed by a management server 410 (illustrated as acts 411, 412, 413, 414, 415, and 416), acts performed by a telematics device 420 (illustrated as acts 421, 422, 423, 424, 425, and 426), and acts performed by a peripheral device 430 (illustrated as acts 431, 432, 433, 434, 435, 438, and 439). One skilled in the art will appreciate that additional acts could be added, acts could be removed, or acts could be reordered as appropriate for a given application. For example, acts 438, 414, 423, 424, 432, 415, and 439 are optional, and could be selectively removed or replaced as appropriate for a given application.

With reference to the examples illustrated in FIGS. 1, 2, and 3, acts can be performed by appropriate components of systems such as system 100 in FIG. 1, system 200 in FIG. 2, and/or system 300 in FIG. 3. For example, acts of transmission, reception, or retrieval can be performed by appropriate communication modules; acts of preparing messages, comparison, determination, installing, or updating can be performed by an appropriate at least one processor; acts of storing or providing access can be performed by an appropriate at least one non-transitory processor-readable storage medium. Further, any of the discussed at least one non-transitory processor-readable storage mediums, can have processor-executable instructions stored thereon, which when executed by a respective at least one processor cause a respective device or component to perform a given act of method 400.

In the context of method 400, firmware is installed at the peripheral device 430. The installed firmware is of a first firmware version, and an indication of the first firmware version can be stored on at least one non-transitory processor-readable storage medium of the peripheral device (such as non-transitory processor-readable storage medium 334 in FIG. 3).

At 438, the peripheral device 430 optionally wakes up. This act is optional, in the sense that in some implementations the peripheral device 430 is already awake or is already otherwise active. In scenarios where act 438 is included, prior to method 400 the peripheral device is in a sleep or low power mode. In some cases, peripheral device 438 is completely deactivated (non-powered) prior to method 400. In some cases, certain functionality or components (e.g. communication module 338) of peripheral device 430 are disabled or non-active so reduce power consumption and/or save connection bandwidth.

Waking the peripheral device 430 at act 438 can be performed in a variety of ways. In a first exemplary implementation, activation of the vehicle where peripheral device 430 is installed triggers waking of the peripheral device 430. For example, telematics device 420 connects to a vehicle data port (such as the OBDII port, via data port 321 discussed with reference to FIG. 3). Telematics device 420 receives an indication of activation of the vehicle via the data port. In response to activation of the vehicle, the telematics device sends a wakeup command to the peripheral device 430, which causes the peripheral device to wake at 438.

The telematics device can receive any appropriate form of activation signal from the vehicle. For example, the telematics device 420 can receive an explicit ignition signal which indicates that the ignition of the vehicle has been activated. As another example, the telematics device 420 can identify activation of the vehicle based on other signals, such as a battery voltage signal from which the telematics device 420 identifies a cranking event of an ignition of the vehicle. As yet another example, the telematics device 420 can receive a signal which explicitly indicates a state of the vehicle, such as Accessory mode or Drive mode, which indicates activation of the vehicle.

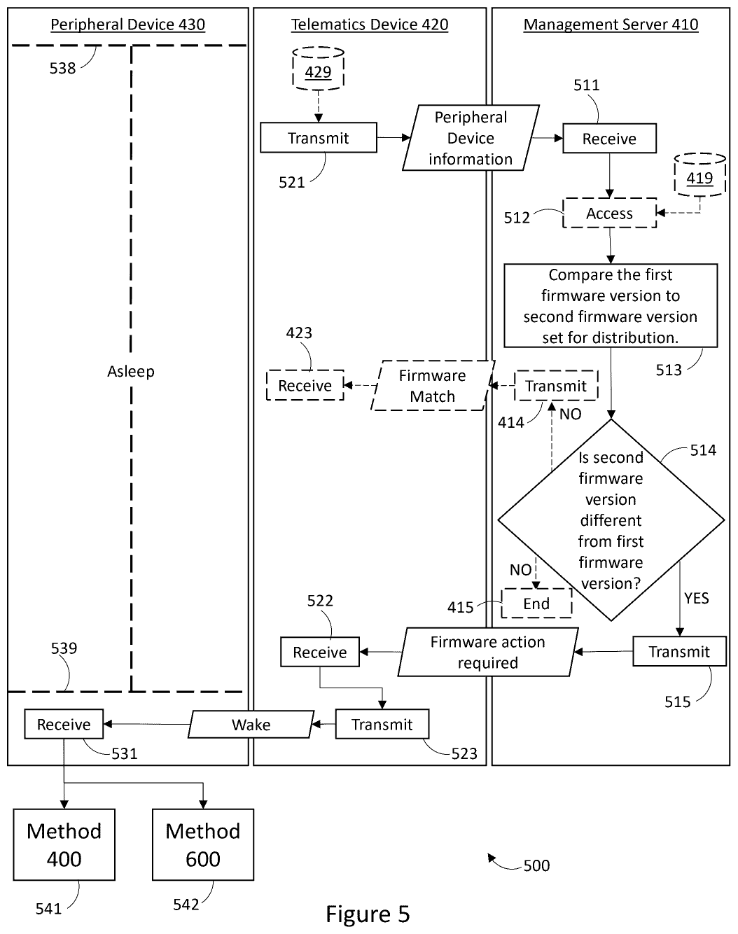

In a second exemplary implementation, waking the peripheral device 430 can be performed even when the vehicle is off (e.g. an ignition of the vehicle is not activated). For example, telematics device 420 can send a wakeup command to peripheral device 430, such as in response to an identified need to update firmware at peripheral device 430 as discussed later with reference to FIG. 5. Such an implementation advantageously keeps peripheral device firmware up to date, even if the vehicle is seldom used.

At 431, the peripheral device 430 transmits an indication of a first firmware version of firmware installed at the peripheral device 430. This transmission is intended for reception at telematics device 420, and is transmitted by a communication module which can communicate with the telematics device (such as the fourth communication module 336 in FIG. 3). The transmission can be prepared or structured by at least one processor of the peripheral device 430 (for example, the at least one processor 332 in FIG. 3 can retrieve the stored first firmware version and package a message indicating the first firmware version for transmission).

At 421, the indication of the first firmware version from the peripheral device 430 is received by the telematics device 420, by a communication module which can communicate with the peripheral device 430 (such as second communication module 326 in FIG. 3). Throughout this disclosure, acts of “receiving” data or information can include any appropriate aspects of such reception, such as intaking, formatting, decompressing, processing, interpreting, or any other actions, as appropriate in a given context.

At 422, the telematics device 420 transmits the indication of the first firmware version of firmware installed at the peripheral device 430. This transmission is intended for reception at management server 410, and is transmitted by a communication module which can communicate with the management server (such as the third communication module 328 in FIG. 3). In some implementations, the telematics device 420 can forward the indication received from the peripheral device 430 at 421 (e.g., without interpretation or processing by the telematics device 420). In other implementations, the telematics device 420 (e.g. by the at least one processor 322 in FIG. 3) can process the indication received from the peripheral device 430 at 421, and prepare another indication of the first firmware version for transmission to the management server (for example, the telematics device 420 may reformat a message indicating the first firmware version, for optimal transmission to the management server 410 over a corresponding communication module).

In yet other implementations, the telematics device 420 can optionally store the indication of the first firmware version received at 421 in a non-transitory processor-readable storage medium thereat, shown as medium 429 in FIG. 4 (which can correspond to for example non-transitory processor-readable storage medium 324 in FIG. 3). The stored indication of the first firmware version can later be accessed, and the indication of the first firmware version transmitted at 422 can be the indication of the first firmware version as accessed from the non-transitory processor-readable storage medium 420. By storing the indication of the first firmware version at telematics device 420 for later transmission, reporting of the first firmware version by the telematics device 420 to the management server 410 can be delayed (or repeated) relative to when the first firmware version is transmitted from the peripheral device 430 to the telematics device 420. In this way, the first firmware version can be transmitted from telematics device 420 even if the peripheral device 430 is asleep (not activated). This can be useful in scenarios where the vehicle is not used (activated) for an extended period of time, as discussed in detail later (e.g. with reference to FIG. 5). For example, when a vehicle is not used for an extended period of time, the telematics device 420 may be asleep most of the time, but may wake periodically to send a status update or communication (e.g. every 24 hour, every week, or any other appropriate length of time). The status update or communication can include the first firmware version for firmware installed at the peripheral device 430. By periodically reporting the first firmware version by the telematics device 420, even if the peripheral device 430 is asleep, it can be determined at the management server 410 when the peripheral device 430 needs a firmware update.

The above-discussed scenario where the first firmware version is reported by the telematics device 420 even if the peripheral device 430 is asleep is one exemplary use case, and the peripheral device 430 is not required to be asleep for act 422 to occur.

At 411, the indication of the first firmware version from the telematics device 420 is received by the management server 410, by a communication module which can communicate with the telematics device (such as first communication module 316 in FIG. 3). Optionally, the received first firmware version can be stored at a non-processor-readable storage medium 419 accessible to the management server 410 (e.g. non-transitory processor-readable storage medium 314 in FIG. 3, or a network storage medium which management server 410 can communicate with). The first firmware version as stored in non-transitory processor-readable storage medium 419 can be accessed and used for checking firmware version of the peripheral device 430 in the future, for example if the peripheral device 430 is not activated for a long period of time as discussed in more detail later with reference to FIG. 5.

At 412, a processor of management server 410 (such as the first at least one processor 312 in FIG. 3) compares the first firmware version to a second firmware version set for distribution to the peripheral device. In particular, when firmware updates are released, they can be made available for distribution to peripheral devices (such as by storing the firmware updates at the management server, or at a datastore separate from the management store). In some implementations, the second firmware version corresponds to a most up-to-date (most recent) firmware version which is compatible with the particular peripheral device from which the indication of the first firmware version is received. This most recent firmware version can be set for distribution of peripheral devices at the server. In other implementations, the second firmware version can be set to a firmware version which is not most recent (e.g., an older firmware version, with the intent to rollback firmware installed at peripheral devices). By comparing the first firmware version to the second firmware version at 412, it can be determined whether the firmware installed at the peripheral device corresponds to the set firmware version (i.e., the firmware version which is indicated as a desired firmware version at the server).

At 413, if the second firmware version is not different from the first firmware version (e.g. if the first firmware version and the second firmware version are the same; that is, the firmware installed at the peripheral device already matches the set firmware version), method 400 illustrates different optional implementations for communicating (or not) that the firmware installed at the peripheral device 430 matches the set firmware version.

In one optional implementation the management server 410 communicates to the peripheral device 430 that the firmware installed at the peripheral device 430 matches the set firmware version (the second firmware version). In method 400 of FIG. 4, at 414, the management server 410 transmits an indication that the firmware installed at the peripheral device 430 matches a set firmware version (e.g. an indication that the first firmware version matches the second firmware version). This transmission is intended for reception at telematics device 420, and is transmitted by a communication module which can communicate with the telematics device (such as the first communication module 316 in FIG. 3). The transmission can be prepared or structured by at least one processor of the management server 410 (for example, the at least one processor 312 in FIG. 3 can prepare a message indicating the first firmware version and the second firmware version, or a message indicating the first firmware version and the second firmware version are equal, for transmission).

At 423, the indication that the firmware installed at the peripheral device 430 matches the set firmware version is received by the telematics device 420, by a communication module which can communicate with the management server 410 (such as third communication module 328 in FIG. 3).

At 424, the telematics device 420 transmits the indication that the firmware installed at the peripheral device 430 matches the set firmware version. This transmission is intended for reception at peripheral device 430, and is transmitted by a communication module which can communicate with the peripheral device 430 (such as the second communication module 326 in FIG. 3). In some implementations, the telematics device 420 can forward the indication received from the management server at 423 (e.g. without interpretation or processing). In other implementations, the telematics device 420 (e.g. by the at least one processor 322 in FIG. 3) can process the indication received from the management server at 423, and prepare another indication that the firmware installed at the peripheral device 430 matches the set firmware version (for example, the telematics device 420 may reformat a message indicating the firmware match, for optimal transmission to the peripheral device over a corresponding communication module).

At 432, the indication that the firmware installed at the peripheral device 430 matches the set firmware version, from the telematics device 420, is received by the peripheral device 430, by a communication module which can communicate with the telematics device 420 (such as fourth communication module 336 in FIG. 3). In this way, the peripheral device 430 is informed that the firmware installed thereat does not need to be changed.

In another optional implementation, the management server 410 does not communicate to the peripheral device 430 that the firmware installed at the peripheral device 430 matches the set firmware version. In particular, at 413 if the second firmware version is the same as the first firmware version of the firmware installed at the peripheral device 430, method 400 ends at 415. Implicitly, since the peripheral device 430 does not receive an indication to update its firmware, the peripheral device 430 can interpret that the firmware installed thereat does not need to be changed.

At 413, if the second firmware version is different from the first firmware version, method 400 continues to act 416, where an updating process is performed to update firmware installed at the peripheral device 430.

At 416, the management server 410 transmits an indication of an access location for firmware data corresponding to the second firmware. For example, the indication of the access location can be an internet link (e.g. Uniform Resource Locator or URL, or any other appropriate format of access location identifier) which leads to a repository or database where the firmware data is stored. The transmission is intended for reception at telematics device 420, and is transmitted by a communication module which can communicate with the telematics device (such as the first communication module 316 in FIG. 3). The transmission can be prepared or structured by at least one processor of the management server 410 (for example, the at least one processor 312 in FIG. 3 can prepare a message indicating the access location, for transmission).

At 425, the indication of the access location is received by the telematics device 420, by a communication module which can communicate with the management server 410 (such as third communication module 328 in FIG. 3).

At 426, the telematics device 420 transmits the indication of the access location. This transmission is intended for reception at peripheral device 430, and is transmitted by a communication module which can communicate with the peripheral device 430 (such as the second communication module 326 in FIG. 3). In some implementations, the telematics device 420 can forward the indication received from the management server at 425 (e.g. without interpretation or processing). In other implementations, the telematics device 420 (e.g. by the at least one processor 322 in FIG. 3) can process the indication received from the management server at 425, and prepare another indication of the access location.

At 433, the indication of the access location is received by the peripheral device 430, by a communication module which can communicate with the telematics device 420 (such as fourth communication module 336 in FIG. 3).

At 434, the peripheral device 430 retrieves the firmware data for the second firmware version from the access location. For example, where the indication of the access location specifies a link or URL from which the firmware data can be downloaded, a communication module of the peripheral device (e.g. the fifth communication module 338 in FIG. 3) accesses the link or URL and downloads the firmware data to at least one storage medium (e.g. the at least one non-transitory processor-readable storage medium 334 in FIG. 3) of the peripheral device.

The access location can be any appropriate location. In some implementations, the access location is a non-transitory processor-readable storage medium of the management server (such as the first at least one non-transitory processor-readable storage medium 314 in FIG. 3). This is shown in FIG. 4 with the firmware data being retrieved from management server 410 at 417. In other implementations, the access location is separate from the management server. For example, the access location can be a remote datastore (e.g. a server which stores firmware for cloud distribution to various devices), such as remote datastore 440 in FIG. 4, storing the firmware data for the second firmware version at 447. A remote datastore can be remote from management server 410, telematics device 420, and peripheral device 430, and from a vehicle in which telematics device 420 and peripheral device 430 are positioned.

At 435, the firmware installed at the peripheral device 430 is updated. For example, a processor of the peripheral device (e.g. the third at least one processor 332 in FIG. 3) can execute or apply the firmware data retrieved at 434, to update or replace existing firmware data at the peripheral device (for example firmware data stored on the third at least one non-transitory processor-readable storage medium 334 in FIG. 3).

Optionally, prior to updating the firmware installed at the peripheral device 430, the peripheral device 430 can wait until the vehicle is deactivated or not in use as shown at 439. In particular, updating the firmware installed at the peripheral device 430 often entails restarting or otherwise rendering the peripheral device 430 non-functional for a period of time. Peripheral device 430 may perform an important function which should not be interrupted while the vehicle is in use, and as such the update at 435 can be delayed until the vehicle is not in use at 439. For example, the peripheral device 430 may receive location, speed, or acceleration data (e.g. from an included sensor or from telematics device 420) which indicates the vehicle is no longer moving. As another example, the peripheral device 430 may receive ignition or vehicle activation data (e.g. from telematics device 420) which indicates that the vehicle is no longer active. In response to identification that the vehicle is not activated or not in use, the peripheral device 430 can perform act 435 and apply the firmware update based on the firmware data for the second firmware version retrieved at 434.

Notably, in method 400 the communication module by which the peripheral device 430 sends the indication of the first firmware version is different from the communication module by which the peripheral device 430 retrieves the firmware data for the second firmware version. That is, the peripheral device 430 sends the indication of the first firmware version to the management server 410 indirectly, via the telematics device 420. In contrast, the peripheral device 430 retrieves the firmware data for the second firmware version more directly (i.e., not via the telematics device). Such an implementation has a number of advantages discussed below.

The telematics device communication module which communicates with the management server (e.g. third communication module 328 in FIG. 3) is already present in telematics-enabled vehicles, and generally at least periodically active, to transmit telematics data to the management server. In contrast, the peripheral device communication module which communicates with the management server (e.g. fifth communication module 338 in FIG. 3) can generally be in an inactive or deactivated mode (e.g. in a shut down or low-power consumption stand by state where communication with the management server is not enabled), and only transitioned to an active state occasionally when needed (e.g. to retrieve firmware data). As such, retrieving the firmware data as in act 434 of method 400 can comprise operating the communication module which connects to the management server (e.g. communication module 338 in FIG. 3) in an active mode where communication with the management server is enabled. Such operation can be achieved by transitioning operational mode of the communication module, such as by for example an internal message within the peripheral device. After the firmware data is retrieved, the communication module 338 can be transitioned back to operating in the inactive mode where communication with the management server is not enabled.

In some implementations, the indication of the first firmware version can be transmitted by the peripheral device 430 periodically (e.g. daily, weekly, monthly), for transmission by the telematics device 420 when the communication module which communicates with the management server 410 is active to transmit telematics data. In other implementations, the indication of the first firmware version can be transmitted by the peripheral device 430 in response to activation of the vehicle and/or activation of the peripheral device 430, as discussed earlier. In either case, overall power consumption is reduced by only activating one long-range communication module. Further, connection subscription costs can be reduced, by only requiring regular activation of one long-range communication module (the third communication module 328 in FIG. 3), while keeping another long-range communication module (the fifth communication module 338 in FIG. 3) in a deactivated or low-power mode until needed on occasion. In such an implementation, a cellular service subscription can be maintained for the long-range communication module of the telematics device, while a different payment model (e.g. a pay-per-use) model could be used for the long-range communication module of the peripheral device.

In some implementations, method 400 can further comprise the telematics device 420 receiving vehicle identification information from a vehicle to which the telematics device is connected. In one implementation, a telematics device can comprise a data port (such as data port 321 in FIG. 3) which communicatively couples to a vehicle (such as vehicle 210 in FIG. 2), over which the telematics device receives information which can be used to identify the vehicle. For example, a VIN (Vehicle Identification Number) can be received by the telematics device from the vehicle. As another example, while a VIN itself may not always be communicated by a vehicle, VIN can be derived from other operational data received by the telematics device from the vehicle. As yet another example, when the telematics device is installed in the vehicle, the vehicle information can be input or otherwise configured, such that at least one non-transitory processor-readable storage medium of the telematics device stores the vehicle identification information. The vehicle identification information is not necessarily limited to VIN (which uniquely identifies a particular vehicle), but can also be information which identifies attributes of a vehicle which are not necessarily unique. For example, the vehicle identification information can indicate make, model, year, fuel type, class, weight, or any other appropriate information about the vehicle.

The received vehicle identification information is transmitted (e.g. by the third communication interface 328 in FIG. 3) for reception at the management server. The management server receives the vehicle identification information (e.g. by the first at least one communication interface 316 in FIG. 3). In such implementations, at 412 in method 400, comparing the first firmware version of firmware installed at the peripheral device to the second firmware version of firmware set for distribution to the peripheral device comprises comparing the first firmware version to the second firmware version set for distribution to the peripheral device and compatible with the vehicle identified in the vehicle identification information. For example, certain peripheral devices which interface with the vehicle may not operate properly if firmware is installed which is not compatible (or tested for compatibility) with the vehicle. As a specific example, a peripheral device could comprise a Bluetooth™ module which provides communication between the telematics device and an infotainment or audio system of the vehicle. If firmware is installed which is not compatible with the infotainment system in a particular vehicle, the functionality of the peripheral device is hindered.

In some cases, vehicles are not used regularly, and as a result telematics devices and peripheral devices at such vehicles may not activate for extended periods of time. Consequently, firmware at such peripheral devices may not be updated in accordance with method 400 regularly or consistently. FIG. 5 discussed below illustrates a method for updating firmware of such devices.

FIG. 5 is a flowchart diagram which illustrates an exemplary method 500 for updating firmware at a peripheral device. Method 500 as illustrated includes acts performed by a management server 410 (illustrated as acts 511, 512, 513, 514, 414, 415, and 515), acts performed by a telematics device 420 (illustrated as acts 521, 423, 522, 523), and acts performed by a peripheral device 430 (illustrated as act 531). One skilled in the art will appreciate that additional acts could be added, acts could be removed, or acts could be reordered as appropriate for a given application. For example, acts 414, 423, and 415 are optional, and could be selectively removed or replaced as appropriate for a given application.

Method 500 is shown including a number of acts (acts 414, 415, and 423) which are also included in method 400 in FIG. 4 and discussed above; discussion of these acts earlier is also applicable to method 500.

The management server 410, telematics device 420, and peripheral device 430 in FIG. 5 are the same as those discussed with reference to method 400 in FIG. 4, and description of these devices with reference to FIG. 4 also applies to FIG. 5.

Similar to method 400, in the context of method 500, firmware is installed at the peripheral device 430. The installed firmware is of a first firmware version.

In some implementations, prior to method 500, an indication of the first firmware version is stored on at least one non-transitory processor-readable storage medium accessible to the management server 410 (shown as 419, and discussed earlier with reference to FIG. 4). The non-transitory processor-readable storage medium 419 can be included in management server 410 (e.g. as non-transitory processor-readable storage medium 314 in FIG. 3), or can be separate from but accessible to management server 410 (e.g. as a network storage device which management server 410 can communicate with). An indication of the first firmware version can be provided to the management server 410 for example in the context of method 400, per acts 431, 421, 422, and 411, and stored at non-transitory processor-readable storage medium 419 as discussed earlier. That is, in such implementations, an instance of method 400 is performed sometime prior to performing method 500, and the first firmware version as reported by the peripheral device 430 in the prior instance of method 400 is stored accessible to the management server 410 for future use in the context of method 500.

In other implementations, prior to method 500, an indication of the first firmware version is stored on at least one non-transitory processor-readable storage medium of the telematics device 420 (shown as 429, and discussed earlier with reference to FIG. 4). That is, in such implementations, an instance of method 400 is performed sometime prior to performing method 500, and the first firmware version as reported by the peripheral device 430 in the prior instance of method 400 is stored at the telematics device 420 for future use in the context of method 500.

In the above implementations, a first instance of method 400 can be performed some time prior to method 500. Method 500 is initiated some time later. For example, method 500 could be initiated when the vehicle has not been activated for a set amount of time, such as 24 hours, 7 days, a month, or any other appropriate amount of time. As another example, method 500 could be initiated when a firmware update or change is made available at the management device 410.

In the context of FIG. 5, peripheral device 430 is asleep or in a non-active state between times 538 and 539 (e.g. because the vehicle where peripheral device 430 is installed is not activated). While time 538 is shown as being relatively close to act 521 at the start of method 500, time 538 can be any amount of time prior to method 500.

At 521, telematics device 420 transmits peripheral device information, such as a unique identifier (ID) of peripheral device 430 (or unique identifiers for a plurality of peripheral devices, if connected). This transmission is intended for reception at management server 410, and is transmitted by a communication module which can communicate with the management server 410 (such as the third communication module 328 in FIG. 3). Prior to act 521 (e.g. as part of installation or initialization of the peripheral device 430), the peripheral device information can be stored at a non-transitory processor-readable storage medium of the telematics device 420 (such as non-transitory processor-readable storage medium 324 in FIG. 3). The transmission of act 521 can be prepared or structured by at least one processor of the telematics device 420 (for example, the at least one processor 322 in FIG. 3 can retrieve the stored peripheral device information and package a message indicating the peripheral device information for transmission).

In some optional implementations where an indication of the first firmware version for firmware installed at the peripheral device 430 is stored at the telematics device 420 (e.g. is stored at non-transitory processor-readable storage medium 429 as discussed earlier as an option with reference to act 421 in method 400). In such implementations, the first firmware version can be included in (or the focus of) the peripheral device information transmitted at 521.

At 511, the peripheral device information is received by the management server 410, by a communication module which can communicate with the telematics device 420 (such as first communication module 316 in FIG. 3). As discussed earlier, “receiving” data or information can include any appropriate aspects of such reception, such as intaking, formatting, decompressing, processing, interpreting, or any other actions, as appropriate in a given context.

Optionally, at 512, the management server 410 accesses an indication of the first firmware version installed at the peripheral device 430, as stored in the at least one non-transitory processor-readable storage medium 419 as discussed earlier. In particular, where the peripheral device information transmitted at 521 does not include an indication of the first firmware version, the indication of the first firmware version as stored in non-transitory processor-readable storage medium 419 is accessed.

In some implementations, receiving the peripheral device information at 511 triggers acts 512 and beyond. In such implementations, the received peripheral device information acts as an indicator of when the telematics device 420 is connected to the network (in communication with management server 410), such that performing a firmware update at peripheral device 430 should be possible (if needed).

In some implementations, act 512 occurs on a regular or periodic basis (e.g. daily, weekly, monthly, or any other appropriate amount of time). In such implementations, receiving the peripheral device information at 511 acts to provide the management server 410 with an indication of at least one connected peripheral device. For example, method 500 can be performed for a plurality of peripheral devices and telematics devices, and the peripheral device information received from each telematics device can be stored accessible to the management server 410 (e.g. in the at least one non-transitory processor-readable storage medium 419). The stored peripheral device information in this example effectively acts as a list of peripheral devices for which the firmware version check at 513 in FIG. 5 should be performed (thus preventing management server 410 from performing act 513 for every conceivable peripheral device, some of which may not be installed or connected).

In some implementations, act 512 and beyond is triggered when a peripheral device firmware change is made available to management server (e.g. a new firmware version is made available).

At 513, the first firmware version installed at peripheral device 430 is compared to a second firmware version set for distribution. The comparison at 513 performed similarly to as discussed regarding act 412 in method 400, and not repeated for brevity. In some implementations, act 513 can be performed based on the first firmware version as indicated in a transmission from the telematics device 420 (e.g. where an indication of the first firmware version is stored at the telematics device 420 and transmitted to management server 410 with the peripheral device information at 521). In other implementations, act 513 can be performed based on an indication of the first firmware version as accessed at 512.

At 514, if the second firmware version is not different from the first firmware version (e.g. if the first firmware version and the second firmware version are the same; that is, the firmware installed at the peripheral device already matches the set firmware version), method 500 illustrates different optional implementations for communicating (or not) that the firmware installed at the peripheral device 430 matches the set firmware version.

In one optional implementation the management server 410 communicates to the telematics device 420 that the firmware installed at the peripheral device 430 matches the set firmware version (the second firmware version). In method 500 of FIG. 5, at 414, the management server 410 transmits an indication that the firmware installed at the peripheral device 430 matches a set firmware version (e.g. an indication that the first firmware version matches the second firmware version). This transmission is intended for reception at telematics device 420, and is transmitted by a communication module which can communicate with the telematics device (such as the first communication module 316 in FIG. 3). The transmission can be prepared or structured by at least one processor of the management server 410 (for example, the at least one processor 312 in FIG. 3 can prepare a message indicating the first firmware version and the second firmware version, or a message indicating the first firmware version and the second firmware version are equal, for transmission).

At 423, the indication that the firmware installed at the peripheral device 430 matches the set firmware version is received by the telematics device 420, by a communication module which can communicate with the management server 410 (such as third communication module 328 in FIG. 3).

In another optional implementation, the management server 410 does not communicate to the telematics device 420 that the firmware installed at the peripheral device 430 matches the set firmware version. In particular, at 514 if the second firmware version is the same as the first firmware version of the firmware installed at the peripheral device 430, method 500 ends at 415. Implicitly, since the telematics device 420 does not receive an indication the peripheral device 430 needs a firmware update, the telematics device 420 can interpret that peripheral device 430 does not need a firmware update.

At 514, if the second firmware version is different from the first firmware version, method 500 continues to act 515, where an updating process is triggered to update firmware installed at the peripheral device 430.

At 515, the management server 410 transmits an indication that firmware action is required at peripheral device 430. The transmission is intended for reception at telematics device 420, and is transmitted by a communication module which can communicate with the telematics device 420 (such as the first communication module 316 in FIG. 3). The transmission can be prepared or structured by at least one processor of the management server 410.

At 522, the indication that firmware action is required is received by the telematics device 420, by a communication module which can communicate with the management server 410 (such as third communication module 328 in FIG. 3).

At 523, in response to receiving the indication that firmware action is required at 522, the telematics device 420 transmits a wake command to the peripheral device 430. The wake command is transmitted by a communication module which can communicate with the peripheral device 430 (such as the second communication module 326 in FIG. 3). At 531, the wake command is received by the peripheral device 430 (e.g. by the fourth communication module 336). The wake command can be any appropriate command which instructs the peripheral device 430 to go from a sleep or non-active mode (e.g. a low-power mode) to a mode suitable for retrieving and applying firmware updates (e.g. a full power mode).

In some implementations, in response to receiving the wake command at 531, method 500 proceeds to method 400 as discussed with reference to FIG. 4 (shown at 541). In this case, waking up the peripheral device 430 at 438 in method 400 is in response to the wake command received at 531 in method 500.

In the course of performing method 400 after method 500, an indication of the first firmware version installed at the peripheral device 430 is transmitted to the management server 410 (acts 431, 421, 422, and 411), and this first firmware version is compared to a second firmware version set for distribution (acts 412 and 413). While this is somewhat redundant with acts 513 and 514 performed in the context of method 500, there are advantages to this approach.

Firstly, performing acts 412 and 413 (in method 400) based on an indication of an installed first firmware version from the peripheral device 430 again after performing acts 513 and 514 confirms the first firmware version installed at the peripheral device 430. For example, firmware installed at peripheral device could have been manually updated after storing the first firmware version at management server 410 or at telematics device 420, such that the first firmware version stored at management server 410 or telematics device 420 is not accurate to firmware installed at peripheral device 430. As another example, firmware at peripheral device 430 may have been updated, but this update may have failed to be reported to management server 410 or telematics device 420 (e.g. due to a communication error).

Secondly, performing the entirety of method 400 after performing method 500 (despite some redundancy) streamlines implementation, by enabling a multipurpose firmware version and update method (method 400) to be utilized regardless of the trigger for initiating method 400 (the same method 400 can be utilized to check and update firmware when the vehicle is activated, and when the peripheral device is woken up by the telematics device as in method 500).

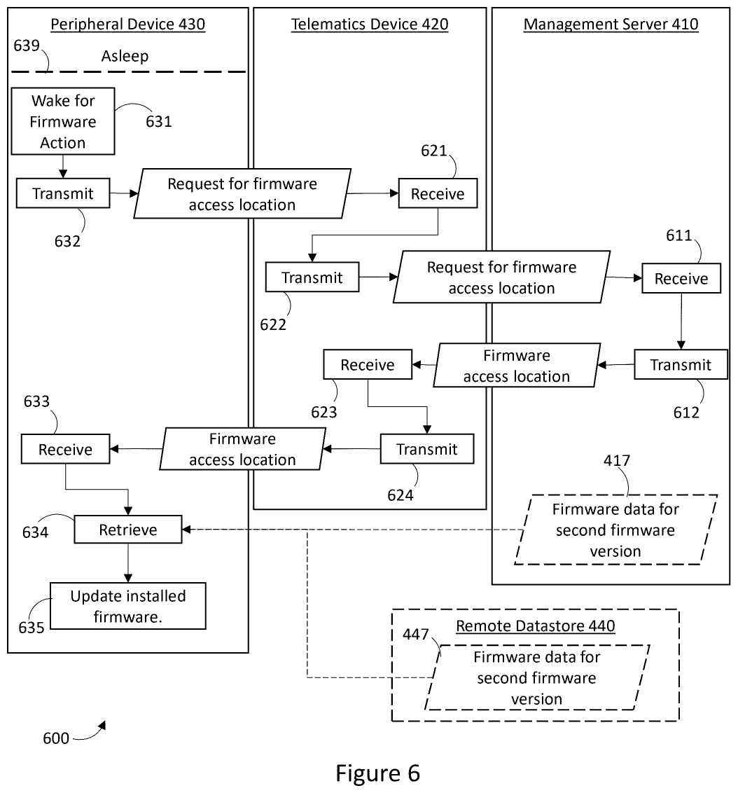

In some implementations, in response to receiving the wake command at 531, method 500 proceeds to method 600 as discussed below with reference to FIG. 6 (shown at 542).

FIG. 6 is a flowchart diagram which illustrates an exemplary method 600 for updating firmware at a peripheral device. Method 600 as illustrated includes acts performed by a management server 410 (illustrated as acts 611 and 612), acts performed by a telematics device 420 (illustrated as acts 621, 622, 623, and 624), and acts performed by a peripheral device 430 (illustrated as acts 631, 632, 633, 634, and 635). One skilled in the art will appreciate that additional acts could be added, acts could be removed, or acts could be reordered as appropriate for a given application. Method 600 in FIG. 6 is performed after an instance of method 500 in FIG. 5, as discussed above.

The management server 410, telematics device 420, and peripheral device 430 in FIG. 6 are the same as those discussed with reference to method 400 in FIG. 4 and method 500 in FIG. 5, and description of these devices with reference to FIGS. 4 and 5 also applies to FIG. 6.

Similar to methods 400 and 500, in the context of method 600, firmware is installed at the peripheral device 430. The installed firmware is of a first firmware version. Prior to 639, peripheral device 430 is asleep or in a non-active state (e.g. operating in a low power mode, because the vehicle is not activated). Prior to method 600, the peripheral device 430 receives a wake command from telematics device 420 (shown as 531 in method 500). In the context of method 600, the wake command indicates that firmware action is needed at peripheral device 430.

At 631, the peripheral device 430 wakes for firmware action, in response to the wake command received at 531 in method 500. At 632, the peripheral device 430 transmits a request for a firmware data access location (i.e. a location from which the second firmware version data can be downloaded, such as a URL to a firmware repository or network device). The request is to solicit an indication of where the second firmware data can be accessed. This transmission is intended for reception at telematics device 420, and is transmitted by a communication module which can communicate with the telematics device 420 (such as the fourth communication module 336 in FIG. 3). The transmission can be prepared or structured by at least one processor of the peripheral device 430, and/or can be based on a stored template.

At 621, the request for firmware data access location from the peripheral device 430 is received by the telematics device 420, by a communication module which can communicate with the peripheral device 430 (such as second communication module 326 in FIG. 3). Throughout this disclosure, acts of “receiving” data or information can include any appropriate aspects of such reception, such as intaking, formatting, decompressing, processing, interpreting, or any other actions, as appropriate in a given context.

At 622, the telematics device 420 transmits the request for firmware data access location. This transmission is intended for reception at management server 410, and is transmitted by a communication module which can communicate with the management server 410 (such as the third communication module 328 in FIG. 3). In some implementations, the telematics device 420 can forward the request received from the peripheral device 430 at 621 (e.g., without interpretation or processing by the telematics device 420). In other implementations, the telematics device 420 (e.g. by the at least one processor 322 in FIG. 3) can process the request received from the peripheral device 430 at 621, and prepare another request for firmware data access location for transmission to the management server 410 (for example, the telematics device 420 may reformat a message requesting firmware data location, for optimal transmission to the management server 410 via communication module 328).

At 611, the request for firmware data access location from the telematics device 420 is received by the management server 410, by a communication module which can communicate with the telematics device (such as first communication module 316 in FIG. 3).

At 612, the management server 410 transmits an indication of firmware data access location for the second firmware version. For example, the indication of the access location can be an internet link (e.g. URL, or any other appropriate format of access location identifier) which leads to a repository or database where the firmware data is stored for the second firmware version. The indication of the access location can be retrieved, for example, for a lookup table or other reference system at the management server 410 which indicates where firmware data can be accessed. This transmission is intended for reception at telematics device 420, and is transmitted by a communication module which can communicate with the telematics device 420 (such as the first communication module 316 in FIG. 3). The transmission can be prepared or structured by at least one processor of the management server 410 (for example, the at least one processor 312 in FIG. 3 can prepare a message indicating the access location, for transmission).

At 623, the indication of the firmware data access location is received by the telematics device 420, by a communication module which can communicate with the management server 410 (such as third communication module 328 in FIG. 3).

At 624, the telematics device 420 transmits the indication of the firmware data access location. This transmission is intended for reception at peripheral device 430, and is transmitted by a communication module which can communicate with the peripheral device 430 (such as the second communication module 326 in FIG. 3). In some implementations, the telematics device 420 can forward the indication received from the management server at 623 (e.g. without interpretation or processing). In other implementations, the telematics device 420 (e.g. by the at least one processor 322 in FIG. 3) can process the indication received from the management server at 623, and prepare another indication of the access location for transmission at 624.

At 633, the indication of the firmware data access location is received by the peripheral device 430, by a communication module which can communicate with the telematics device 420 (such as fourth communication module 336 in FIG. 3).

At 634, the peripheral device 430 retrieves the firmware data for the second firmware version from the firmware data access location (similarly to as discussed earlier with reference to act 434 in FIG. 4 earlier). For example, where the indication of the access location specifies a link or URL from which the firmware data can be downloaded, a communication module of the peripheral device (e.g. the fifth communication module 338 in FIG. 3) accesses the link or URL and downloads the firmware data to at least one storage medium (e.g. the at least one non-transitory processor-readable storage medium 334 in FIG. 3) of the peripheral device 430.

The access location can be any appropriate location, similarly to as discussed with reference to FIG. 4. In some implementations, the firmware data access location is a non-transitory processor-readable storage medium of the management server 410 (such as the first at least one non-transitory processor-readable storage medium 314 in FIG. 3). This is shown in FIG. 6 with the firmware data being retrieved from management server 410 at 417. In other implementations, the firmware data access location is separate from the management server 410. For example, the firmware data access location can be a remote datastore (e.g. a server which stores firmware for cloud distribution to various devices), such as remote datastore 440 in FIG. 6, storing the firmware data for the second firmware version at 447. A remote datastore can be remote from management server 410, telematics device 420, and peripheral device 430, and from a vehicle in which telematics device 420 and peripheral device 430 are positioned.

At 635, the firmware installed at the peripheral device 430 is updated, similarly to as discussed earlier with reference to act 435 in FIG. 4. For example, a processor of the peripheral device (e.g. the third at least one processor 332 in FIG. 3) can execute or apply the firmware data retrieved at 634, to update or replace existing firmware data at the peripheral device (for example firmware data stored on the third at least one non-transitory processor-readable storage medium 334 in FIG. 3).

In the context of method 500, proceeding to method 400 at 541 has the advantages discussed earlier, namely simplifying an instruction or function set at the peripheral device, and ensuring the first firmware version assumed by the management device at 513 corresponds to the actual first firmware version at the peripheral device 430. In contrast, proceeding to method 600 at 542 instead advantageously reduces the number of additional acts to update the firmware at the peripheral device 430 (compared to performing the entirety of method 400 after method 500), and thus can save processing resources, bandwidth, and power. As a result, whether method 400 or method 600 is performed after method 500 is a tradeoff, with each strategy providing different benefits.

While the present invention has been described with respect to the non-limiting embodiments, it is to be understood that the invention is not limited to the disclosed embodiments. Persons skilled in the art understand that the disclosed invention is intended to cover various modifications and equivalent arrangements included within the scope of the appended claims. Thus, the present invention should not be limited by any of the described embodiments.

Throughout this specification and the appended claims, infinitive verb forms are often used, such as “to operate” or “to couple”. Unless context dictates otherwise, such infinitive verb forms are used in an open and inclusive manner, such as “to at least operate” or “to at least couple”.

The Drawings are not necessarily to scale and may be illustrated by phantom lines, diagrammatic representations, and fragmentary views. In certain instances, details that are not necessary for an understanding of the exemplary embodiments or that render other details difficult to perceive may have been omitted.

The specification includes various implementations in the form of block diagrams, schematics, and flowcharts. A person of skill in the art will appreciate that any function or operation within such block diagrams, schematics, and flowcharts can be implemented by a wide range of hardware, software, firmware, or combination thereof. As non-limiting examples, the various embodiments herein can be implemented in one or more of: application-specific integrated circuits (ASICs), standard integrated circuits (ICs), programmable logic devices (PLDs), field-programmable gate arrays (FPGAs), computer programs executed by any number of computers or processors, programs executed by one or more control units or processor units, firmware, or any combination thereof.

The disclosure includes descriptions of several processors. Said processors can be implemented as any hardware capable of processing data, such as application-specific integrated circuits (ASICs), standard integrated circuits (ICs), programmable logic devices (PLDs), field-programmable gate arrays (FPGAs), logic circuits, or any other appropriate hardware. The disclosure also includes descriptions of several non-transitory processor-readable storage mediums. Said non-transitory processor-readable storage mediums can be implemented as any hardware capable of storing data, such as magnetic drives, flash drives, RAM, or any other appropriate data storage hardware. Further, mention of data or information being stored at a device (e.g. vehicle device 122 or network device 110) generally refers to the data information being stored at a non-transitory processor-readable storage medium of said device (e.g. non-transitory processor-readable storage mediums 116 or 126).

What is claimed is:

1. A method performed between a management server having a first communication module, a telematics device having a second communication module and a third communication module, and a peripheral device having a fourth communication module and a fifth communication module, the method comprising:
transmitting, by the fourth communication module of the peripheral device to the second communication module of the telematics device, an indication of a first firmware version of firmware installed at the peripheral device;
transmitting, by the third communication module of the telematics device to the first communication module of the management server, the indication of the first firmware version;
comparing, by a first at least one processor of the management server, the first firmware version to a second firmware version set for distribution to the peripheral device;
in response to a determination that the second firmware version is different from the first firmware version, transmitting, by the first at least one communication module of the management server to the third communication module of the telematics device, an identification of an access location for firmware data corresponding to the second firmware version;
transmitting, by the second communication module of the telematics device, the identification of the access location to the fourth communication module of the peripheral device;
retrieving, by the fifth communication interface of the peripheral device, the firmware data corresponding to the second firmware version from the access location; and
updating, by a second at least one processor at the peripheral device, the firmware installed at the peripheral device based on the firmware data retrieved from the access location.

2. The method of claim 1, wherein the fifth communication module is normally in an inactive mode where communication with the management server is not enabled, and retrieving the firmware data corresponding to the second firmware version further comprises:
operating the fifth communication module in an active mode where communication with the management server is enabled.

3. The method of claim 2, further comprising:
after retrieving the firmware data corresponding to the second firmware version, operating the fifth communication module in the inactive mode.

4. The method of claim 1, further comprising:
receiving, by the telematics device, vehicle identification information from a vehicle to which the telematics device is connected; and
transmitting, by the third communication interface for reception at the management server, the vehicle identification information,
wherein
comparing the first firmware version of the peripheral device to a second firmware version set for distribution to the peripheral device comprises comparing the first firmware version of the peripheral device to a second firmware version set for distribution to the peripheral device and compatible with the vehicle identified in the vehicle identification information.

5. The method of claim 1, wherein the second firmware version is a most recent firmware version.

6. The method of claim 1, wherein transmitting, by the fourth communication module of the peripheral device to the second communication module of the telematics device, the indication of the first firmware version of firmware installed at the peripheral device comprises transmitting the indication of the first firmware version in response to waking of the peripheral device.

7. The method of claim 1, wherein updating, by the second at least one processor, the firmware installed at the peripheral device based on the firmware data retrieved from the access location comprises updating the firmware installed at the peripheral device after deactivation of vehicle where the peripheral device is positioned.

8. The method of claim 1, further comprising:
accessing, at a non-transitory processor-readable storage medium accessible to the management server, a stored indication of an assumed firmware version for firmware installed at the peripheral device;
comparing, by the first at least one processor, the assumed firmware version indicated in the stored indication to the second firmware version set for distribution;
in response to a determination that the second firmware version is different from the assumed firmware version indicated in the stored indication, transmitting, by the first at least one communication module for reception at the telematics device, an indication for firmware action at the peripheral device;
receiving, by the third communication module of the telematics device, the indication for firmware action;
in response to receiving the indication for firmware action, transmitting, by the second communication module, a wake command;
receiving, by the fourth communication module, the wake command; and
waking the peripheral device,
wherein transmitting, by the fourth communication module of the peripheral device, the indication of the first firmware version comprises transmitting the indication of the first firmware version in response to the peripheral device being woken.

9. The method of claim 1, further comprising:
storing, by the second at least one non-transitory processor-readable storage medium of the telematics device, the indication of the first firmware version received from the peripheral device; and
accessing, by the telematics device, the indication of the first firmware version from the second at least one non-transitory processor-readable storage medium,
wherein transmitting, by the third communication module of the telematics device, the indication of the first firmware version comprises transmitting the indication of the first firmware version as accessed from the second at least one non-transitory processor-readable storage medium.

10. A system comprising:
a management server having a first at least one communication module, a first at least one processor, and a first at least one non-transitory processor readable storage medium storing first processor-executable instructions thereon; and
a telematics device having a second communication module, a third communication module, a second at least one processor, and a second at least one non-transitory processor readable storage medium storing second processor-executable instructions thereon,
wherein:
the second processor-executable instructions cause the telematics device to:
receive, by the second communication module, an indication of a first firmware version of firmware installed at a peripheral device communicatively coupled to the telematics device; and
transmit, by the third communication module for reception at the management server, the indication of the first firmware version;
the first processor-executable instructions cause the management server to:
receive, by the first at least one communication module, the indication of the first firmware version from the telematics device;
compare, by the first at least one processor, the first firmware version to a second firmware version set for distribution to the peripheral device; and
in response to a determination that the second firmware version is different from the first firmware version, transmit, by the first at least one communication module for reception at the telematics device, an identification of an access location for firmware data corresponding to the second firmware version; and
the second processor-executable instructions further cause the telematics device to:
receive, by the third communication module, the identification of the access location from the management server; and
transmit, by the second communication module, the identification of the access location for reception and subsequent retrieval of the firmware data corresponding to the second firmware version from the access location by the peripheral device.

11. The system of claim 10, wherein the second communication module comprises a wired communication module, for wired communication between the telematics device and the peripheral device.

12. The system of claim 10, wherein the second communication module comprises a short-range wireless communication module.

13. The system of claim 10, wherein the third communication module comprises a cellular modem at the telematics device which communicates over a cellular network.

14. The system of claim 10, wherein the first at least one communication module comprises a network module which communicatively couples to a cloud network or the internet.

15. The system of claim 10, wherein the access location comprises the first at least one non-transitory processor-readable storage medium.

16. The system of claim 10, wherein the access location comprises another at least one non-transitory processor-readable storage medium at a datastore remote from the peripheral device, the telematics device, and the management server.

17. The system of claim 10, wherein the telematics device is positioned at a vehicle where the peripheral device is positioned, and the management server and the access location are remote from the vehicle.

18. The system of claim 10, wherein:
the second processor-executable instructions further cause the telematics device to:
receive vehicle identification information from a vehicle to which the telematics device is connected; and
transmit, by the third communication interface for reception at the management server, the vehicle identification information; and
the first processor-executable instructions which cause the management server to compare the first firmware version to the second firmware version set for distribution to the peripheral device cause the first at least one processor to compare the first firmware version to the second firmware version set for distribution to the peripheral device and compatible with the vehicle identified in the vehicle identification information.

19. The system of claim 10, wherein the second firmware version is a most recent firmware version.

20. The system of claim 10, wherein:
the second processor-executable instructions further cause the telematics device to store, by the second at least one non-transitory processor-readable storage medium, the indication of the first firmware version;
the second processor-executable instructions further cause the telematics device to access the indication of the first firmware version from the second at least one non-transitory processor-readable storage medium; and
the second processor-executable instructions which cause the third communication module of the telematics device to transmit the indication of the first firmware version cause the third communication module to transmit the indication of the first firmware version as accessed from the second at least one non-transitory processor-readable storage medium.
